(19) United States
(12) Patent Application Publication
(10) Pub. No.: US 2012/0047721 A1
(43) Pub. Date: Mar. 1, 2012

(54) SYSTEM AND METHOD FOR INSTALLING SHOWER WALLS

(75) Inventors: Brian John WATSON, London (GB); Philip Mark HALL, London (GB); Anthony Arthur WILLS, London (GB); Steve GEORGE, Tigard, OR (US)

(73) Assignee: VERTEX STONE AND CHINAWARE LTD., Hong Kong (CN)

(21) Appl. No.: 12/868,352

(22) Filed: Aug. 25, 2010

(51) Int. Cl. B23P 19/00

(52) U.S. Cl. 29/700

(57) ABSTRACT

The system for installing shower walls includes a pressure transfer member for urging a shower wall against a back up support during bonding of the shower wall to the support. An adjustable force development device engages the pressure transfer member to force the pressure transfer member against the shower wall. A support member engages the pressure transfer member when the force development device exerts a predetermined force against the shower wall. A fixation device holds the support member to maintain the pressure transfer position of the pressure transfer member. The fixation device includes a cam that moves a shower wall into a tight corner fit with an adjacent shower wall.

### BACKGROUND OF THE INVENTION

This invention relates to systems and methods for building shower enclosures, and more particularly to a system and method for installing shower walls in a shower enclosure.

Shower enclosures are usually set up and installed by professionals, especially when the shower walls for such enclosures are formed of a one-piece material such as natural or artificial stone. Stone shower walls generally require custom sizing, and skilled handling for installation in a shower enclosure. The expenses and complexity of such installation may discourage a do-it-yourselfer from using stone or other similar unitary wall structures in shower enclosures.

As used herein the term “shower enclosure” is intended to refer to a shower chamber or shower stall with two or more shower walls, and is closable by a shower door, and can also include one or more fixed glass or plastic panels that extend away from the shower walls to the shower door.

In accordance with the invention unitary shower wall structures (also referred to as shower walls) can be made in predetermined sizes and packaged individually or in a kit. The invention also includes novel installation tools that enable a do-it-yourselfer to install the shower walls. Thus the present system for installing shower walls is amenable for mass marketing as one or more off-the-shelf products.

### DESCRIPTION OF THE DRAWINGS

In the accompanying drawings,

FIG. 1A to FIG. 1X are simplified pictorial diagrams showing the development of a shower enclosure and the installation of shower walls in the shower enclosure using the system for installing shower walls;

FIG. 2 is a simplified plan view showing one embodiment of the system for installing shower walls, for a three wall shower enclosure;

FIG. 3 is a simplified plan view of another embodiment of the system for installing shower walls, for a two wall shower enclosure;

FIG. 4 is an enlarged perspective view of the system of FIG. 2 with the backup support walls of the shower enclosure being generally omitted for purposes of clarity;

FIG. 5 is an enlarged perspective front view of a cam tool and holding device for the system, positioned against an edge of one of the shower walls;

FIG. 6 is an enlarged perspective rear view of the cam tool and holding device of FIG. 4;

FIG. 7 is an enlarged perspective view of an adjustable force development device for the system, including a crank assembly;

FIG. 8 is an exploded view of the crank assembly of FIG. 7.

FIG. 9 is a perspective view of one pressure transfer member of the system;

FIG. 10 is a perspective view of another pressure transfer member of the system;

FIG. 11 is a rear view of the cam tool and holding device of FIG. 6, showing the cam head in contact with the cam follower, and the molded ribs of FIG. 6 being omitted for purposes of clarity;

FIG. 12 is an auxiliary view of the cam tool and holding device taken on the line 12-12 of FIG. 11; and,

FIG. 13 is a view similar to FIG. 11 showing another position of the cam head relative to the cam follower;

Corresponding reference numbers indicate corresponding parts throughout the several views of the drawings.

### DETAILED DESCRIPTION OF THE INVENTION

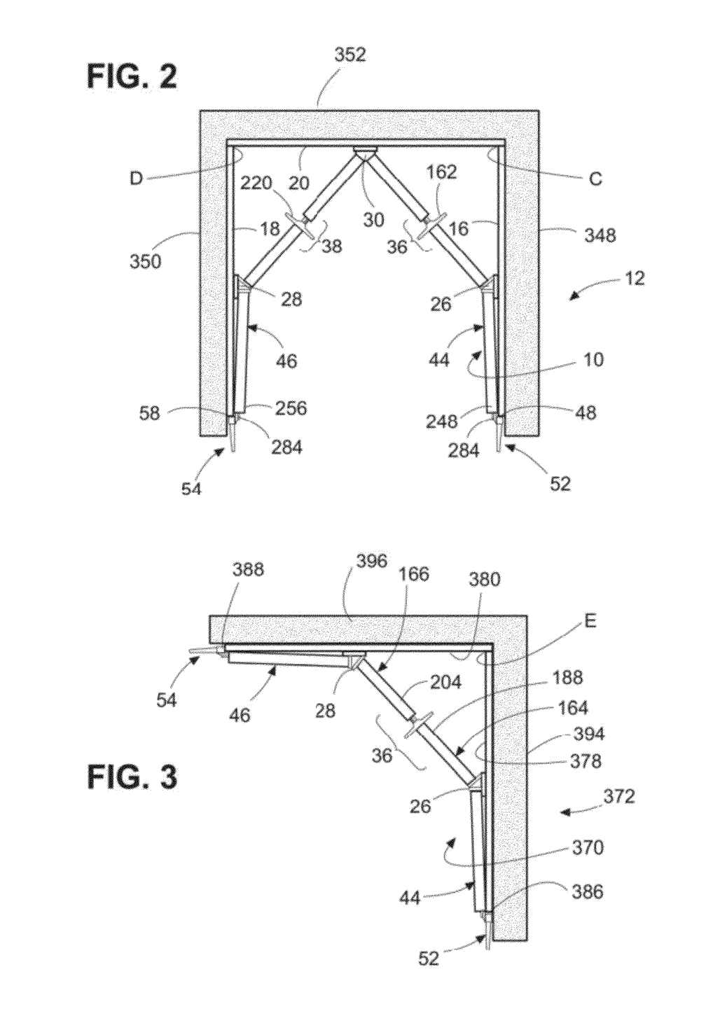

One embodiment of a system for installing shower walls in a three-wall shower enclosure is generally indicated by the reference number 10 in FIG. 2. The three-wall shower enclosure is generally indicated by the reference number 12, and includes sidewalls 16, 18 and a rear wall 20.

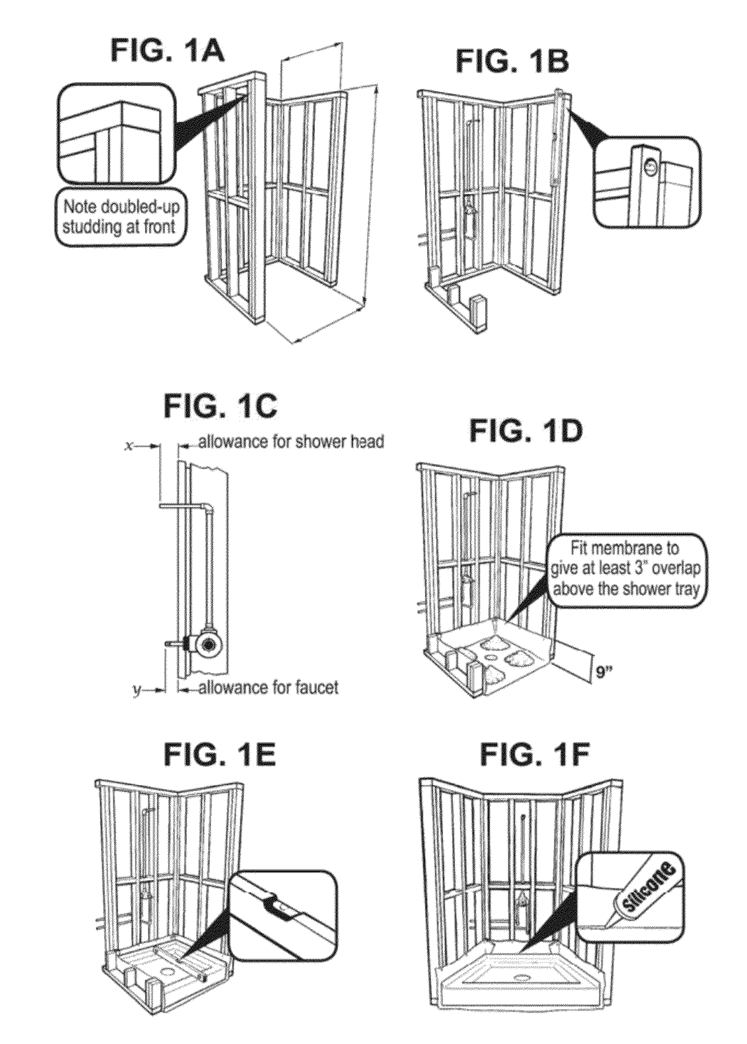

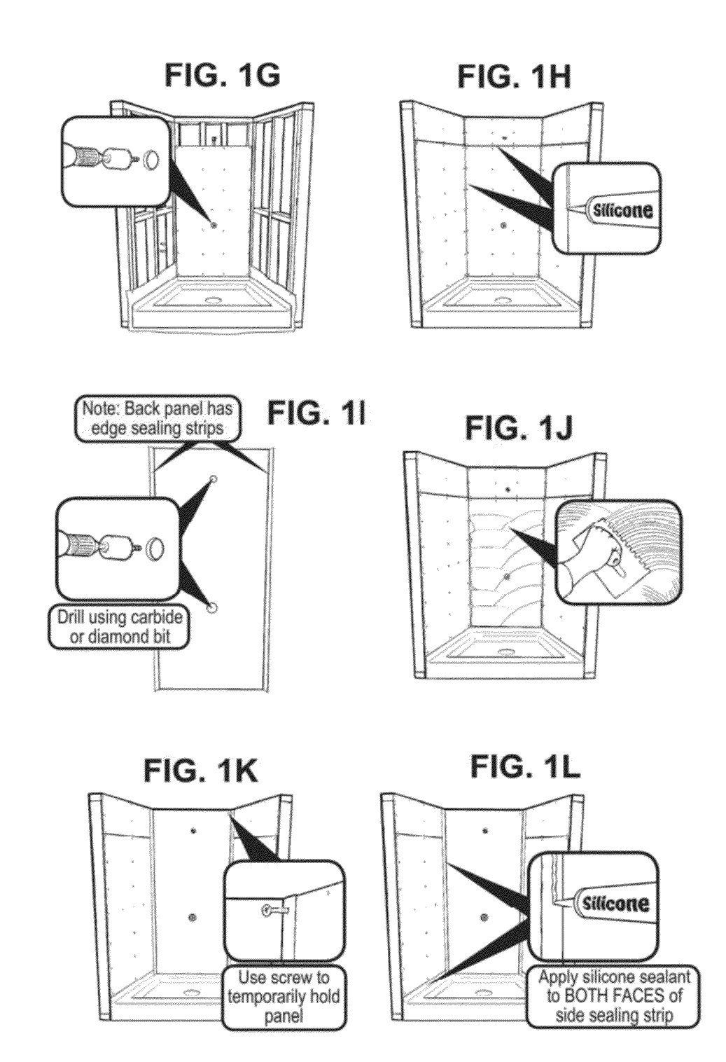

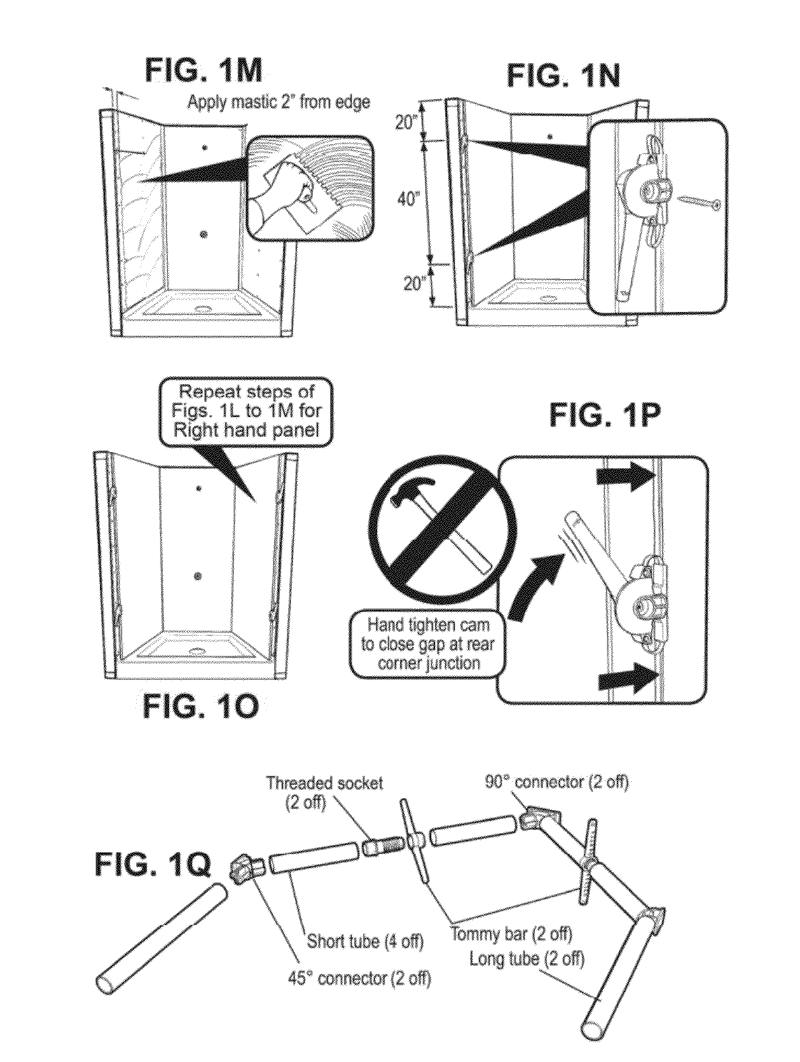

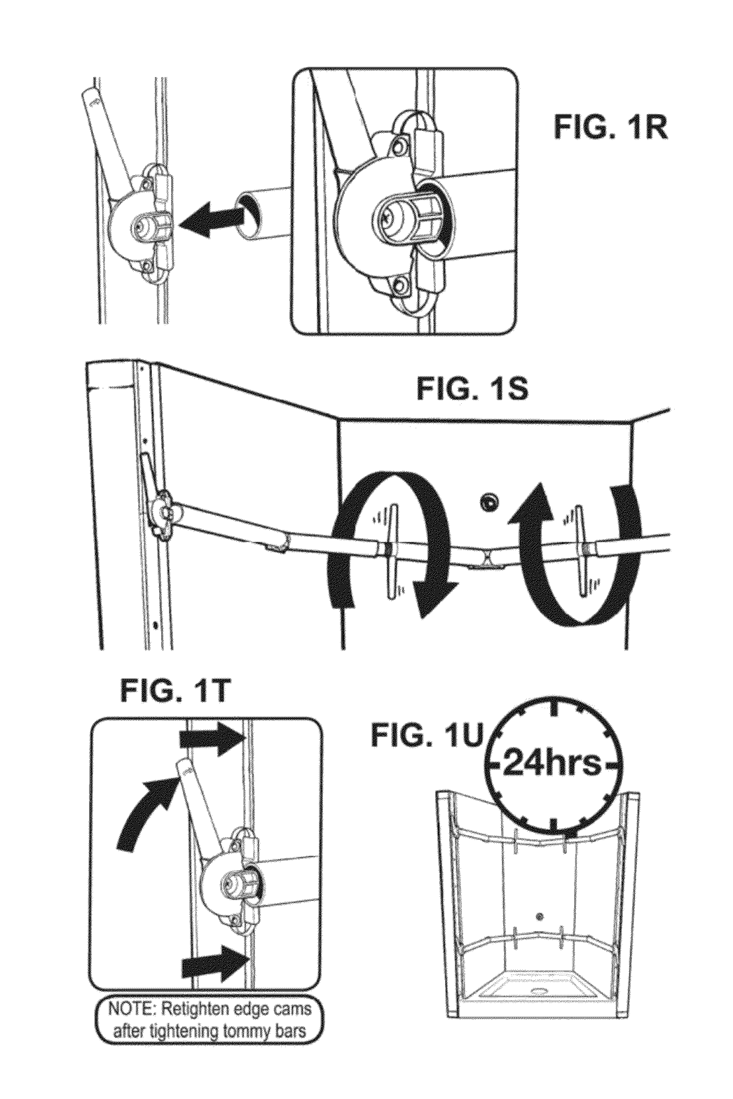

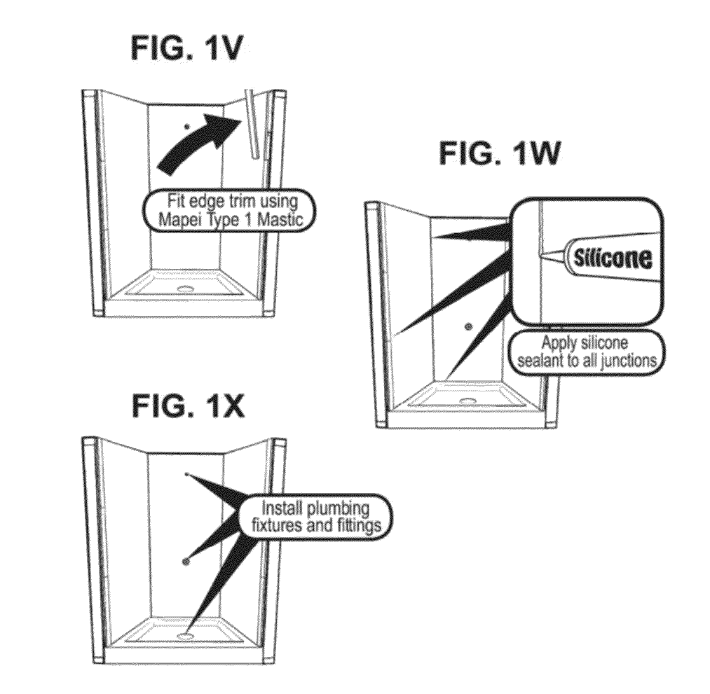

The development of a three-wall shower enclosure is shown in simplified pictorial fashion in FIGS. 1A to 1H.

FIG. 1A to FIG. 1F show a preferred structural framework for a three wall shower enclosure.

FIGS. 1G to 1H show the installation of backup support walls for the shower walls, and a shower floor tray with a drain for the shower enclosure.

FIGS. 1I to 1M show a bonding material being provided on the front of the backup support walls for securement of the shower walls on the backup support walls.

FIGS. 1M to 1U show the shower walls in their initial placement position against the backup support walls.

FIGS. 1N to 1U show the system for holding or installing the shower walls in a desired securement position against the backup support walls in the shower enclosure until a bonding material for the shower walls dries and cures.

FIGS. 1V to 1X show finishing operations for the shower walls after the shower walls are sufficiently secured in the shower enclosure.

It should be noted that any structural dimensions and bonding material cure times indicated in FIG. 1A to FIG. 1X are for example, and are not intended to exclude other feasible dimensions or cure times.

Each shower wall is preferably a laminate of a natural or synthetic stone material such as granite or marble, or a synthetic stone-like material bonded to a backup support layer. The stone or stone-like layer can be approximately 4 mm thick, for example. A suitable bonding adhesive is a combination of Magpow Aluminum Honeycomb Compound Glues 1693A, 1693B, 1693-1(A) and 1693-1(B).

The backup layer for the stone or synthetic stone layer is preferably formed of a flexible PVC material that is fluted at its rear surface. The fluting can be accomplished with a BF2010022 die. The fluted surface provides the backup layer with a desired yieldability under pressure. Such yieldability helps ensure a secure bond between the shower walls and the backup support walls in the shower enclosure.

Referring to FIG. 2 of the drawings, the system 10 for installing the shower walls is used to press against and hold in a desired securement position the side shower walls 16, 18 and the rear shower wall 20 (FIGS. 2 and 3) of the shower enclosure 12, until a bonding material (FIGS. 1H, 1L and 1M) for the shower walls 16, 18 and 20 dries or cures to create a secure bond.

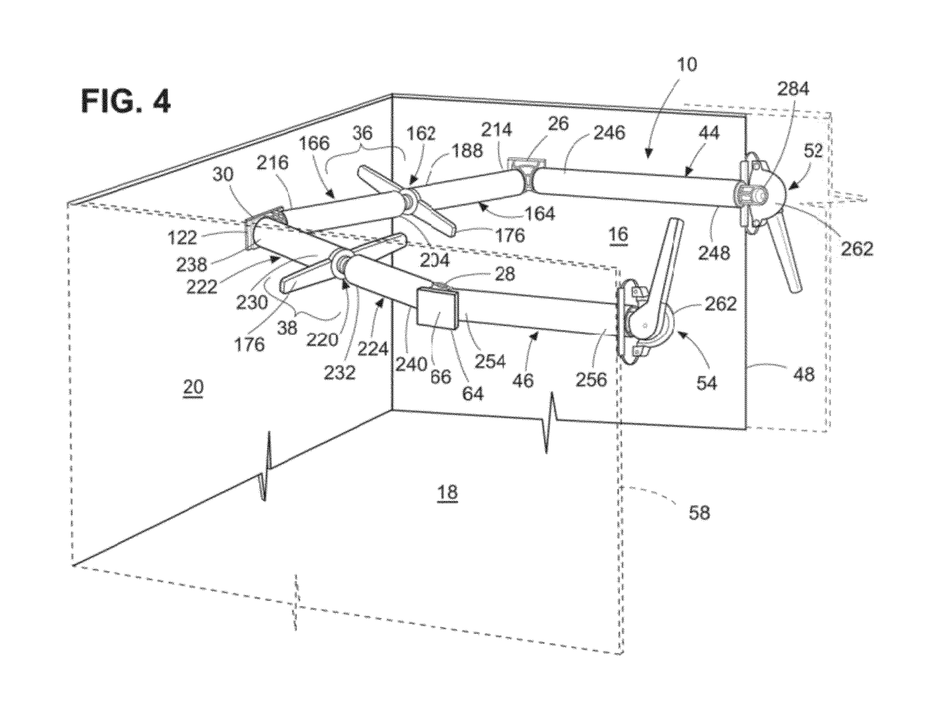

As shown in FIG. 1X one shower wall installation system, identified by the reference number 10 in FIGS. 2 and 4, can be used at an upper portion of the shower walls and a second shower wall installation system can be used at a lower portion of the shower walls.

The system 10 (FIGS. 2 and 4) includes pressure transfer members 26 and 28 for the side shower walls 16 and 18, and a pressure transfer member 30 for the rear shower wall 20. Pressure is applied to the pressure transfer members 26, 28 and 30 by adjustable force development devices 36 and 38 (FIG. 2) which engage the pressure transfer members 26, 28 and 30.

The system 10 (FIGS. 2 and 4) further includes support members in the form of elongated struts or pipes 44, 46 which can be formed of any suitable material such as 1½ inch diameter plastic tube, which respectively engage the pressure transfer members 26 and 28.

The system 10 also includes a combination cam tool and holding device 52 (FIGS. 2 and 4) that engages the support member 44 and an edge 48 of the sidewall 16.

The system 10 further includes an identical cam tool and holding device 54 (FIGS. 2 and 4) that engages the support member 46 and an edge 58 of the sidewall 18.

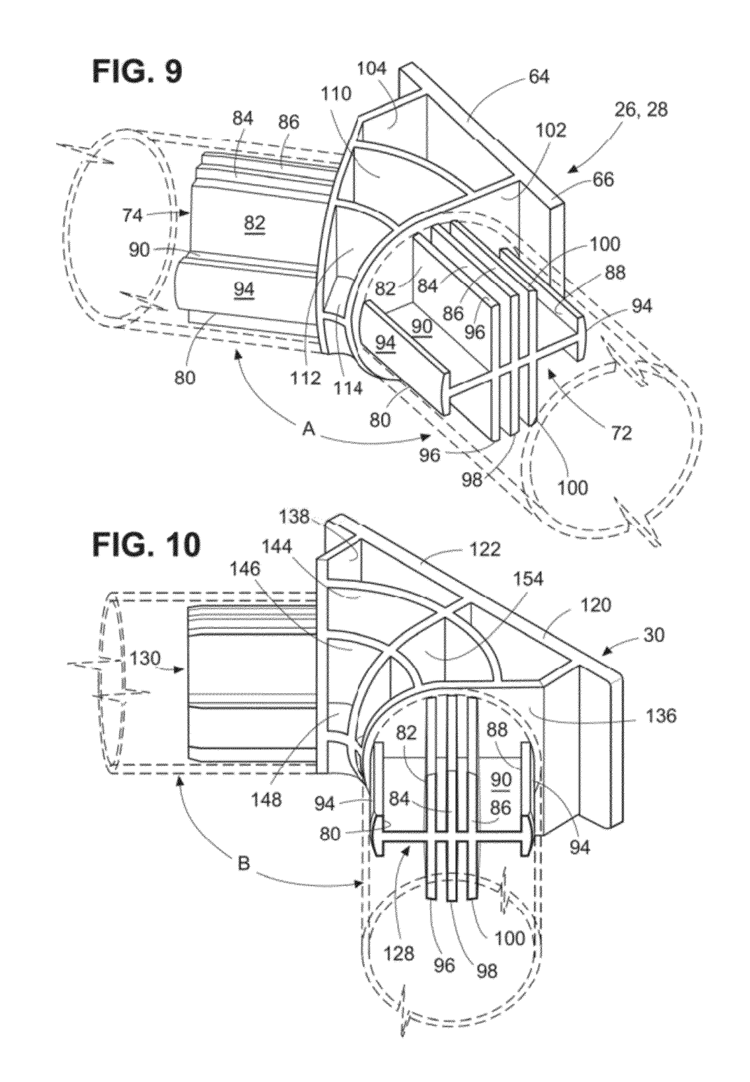

The pressure transfer members 26 and 28 (FIG. 9) include a base portion 64 having a pressure transfer surface 66 (FIG. 4) that is directed against the respective shower walls 16 and 18 (FIGS. 2 and 4). The pressure transfer members 26 and 28 (FIG. 9) also include engagement arms 72 and 74 that have an intersection angle A of approximately 135°, although other angles are also feasible.

The arms 72 and 74 (FIG. 9) have upper and lower fins 80, 82, 84, 86 and 88 that extend upwardly and downwardly from a shelf 90. The fins 82, 82, 84, 86 and 88 provide the arms 72 and 74 with strength, rigidity and lightness of weight.

The fins 80 and 88 (FIG. 9) have contact surfaces 94 and the fins 82, 84 and 86 have opposite contact edges 96, 98 and 100. The contact surfaces 94 and the contact edges 96, 98 and 100 are elements or segments of an imaginary cylindrical surface.

The arms 72 and 74 (FIG. 9) project from spaced sidewalls 102 and 104 that extend from the base portion 64 and are joined by ribs 110, 112 and 114. The pressure transfer members 26 and 28 are preferably molded from a suitable known plastic.

The pressure transfer member 30 (FIG. 10) includes a base portion 120 having a pressure transfer surface 122 that is directed against the rear shower wall 20 (FIG. 4). The pressure transfer member 30 also includes engagement arms 128 and 130 that have an intersection angle B of approximately 90°, although other angles are also feasible.

The engagement arms 128 and 130 are finned in the same manner as the arms 72 and 74 of the pressure transfer members 26 and 28, and are thus identified by corresponding reference numbers.

The arms 128 and 130 (FIG. 10) project from spaced sidewalls 136 and 138 that extend from the base portion 120. The sidewalls 136 and 138 are joined by ribs 144, 146 and 148 that also intersect a median wall 154 that extends from the base portion 120. As with the pressure transfer members 26 and 28 the pressure transfer member 30 is preferably molded from a suitable known plastic material.

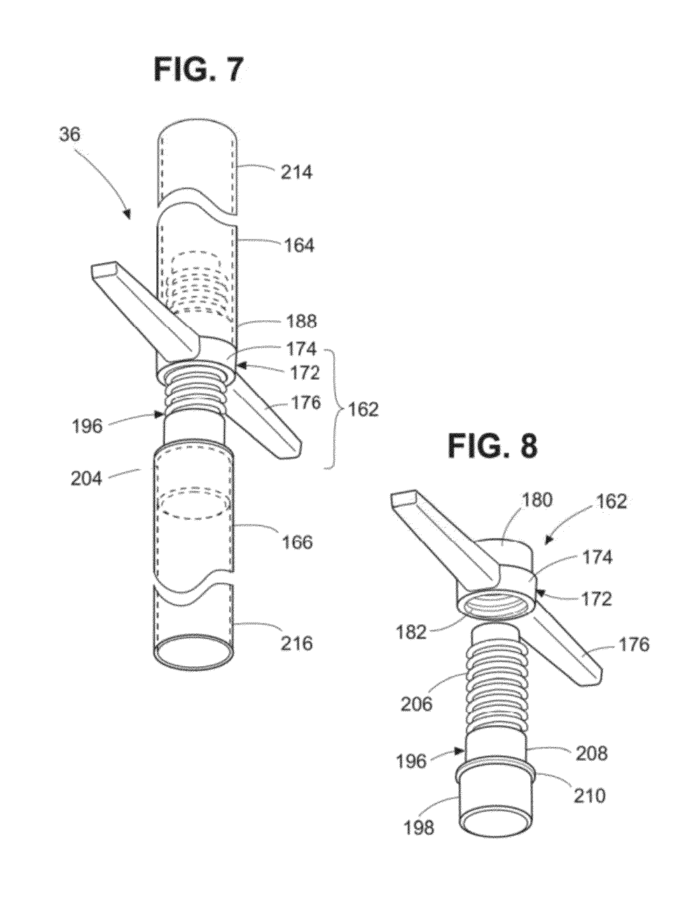

The adjustable force development device 36 (FIGS. 2, 4 and 7), which is identical to the force development device 38, includes a threaded jack assembly or threaded Tommy bar assembly 162 cooperable with a pair of elongated struts 164 and 166 (FIGS. 4 and 7).

As shown in FIGS. 7 and 8, the jack assembly 162 includes a hollow crank member 172 having a central hub portion 174 with a turn handle 176. The hub portion 174 has a projecting end 180 (FIG. 8) of reduced diameter. The crank member 172 is provided with internal threads 182.

The projecting end 180 fits into an end 188 (FIGS. 4 and 7) of the strut 164 for relative turning movement with respect to the strut 164 via the turn handle 176.

The jack assembly 162 also includes a hollow externally threaded member 196 (FIGS. 7 and 8) having a strut engaging end 198 (FIG. 8) that fits tightly or is locked into a confronting open end 204 of the strut 166. The tight fit or lock fit prevents relative movement of the externally threaded member 196 with respect to the strut 166.

The externally threaded member 196 has a threaded portion 206 on a reduced diameter section 208 that extends away from the strut engaging end 198. A peripheral bead 210 that limits insertion of the threaded member 196 into the strut 166 is formed on the strut engaging end 198 where it intersects the reduced diameter section 208. The threaded portion 206 is engageable with the internal threads 182 of the rotatable crank member 172 as shown in FIG. 7.

Under this arrangement, rotation of the turn handle 176 of the jack assembly 162 (FIG. 8) causes threaded movement of the crank member 172 relative to the nonturnable threaded member 196, to provide a desired spacing between the confronting ends 188 and 204 (FIGS. 4 and 7) of the struts 164 and 166.

An opposite force transmitting end 214 of the strut 164 (FIGS. 4 and 8) engages the pressure transfer member 26 at the arm 74 (FIG. 9). An opposite force transmitting end 216 (FIGS. 2 and 8) of the strut 166 (FIGS. 4 and 7) engages the pressure transfer member 30 at the arm 128 (FIG. 10).

The struts 164 and 166 can be formed of any suitable material such as 1½ inch diameter plastic tube.

The force development device 38 includes a threaded crank assembly 220, identical to the crank assembly 162, cooperable with a pair of elongated struts 222 and 224, (FIG. 4) identical to the struts 164 and 166. The force development device 38 is assembled and operates in a manner similar to that previously described for the force development device 36.

Thus, an end 230 (FIG. 4) of the strut 222 engages the crank member 172 of the jack assembly 220. A confronting end 232 of the strut 224 (FIG. 4) engages the externally threaded member 196 of the jack assembly 220. Under this arrangement turning movement of the turn handle 176 provides a desired spacing between the confronting ends 230 and 232 of the struts 222 and 224.

An opposite force transmitting end 238 (FIG. 4) of the strut 222 engages the pressure transfer member 30 at the arm 130 (FIG. 10). An opposite force transmitting end 240 of the strut 224 engages the pressure transfer member 28 (FIG. 4) at the arm 72 (FIG. 9). Thus turning of the turn handle 176 of the jack assembly 220 provides a desired spacing between the confronting ends 230 and 232 of the struts 222 and 224.

The elongated support member 44 has an end 246 (FIG. 4) that engages the pressure transfer member 26 at the arm 72 (FIG. 9). An opposite end 248 of the support member 44 engages the cam tool and holding device 52.

Similarly, the elongated support member 46 has an end 254 (FIG. 4) that engages the pressure transfer member 28 at the arm 72 (FIG. 9). An opposite end 256 of the support member 46 engages the cam tool and holding device 54.

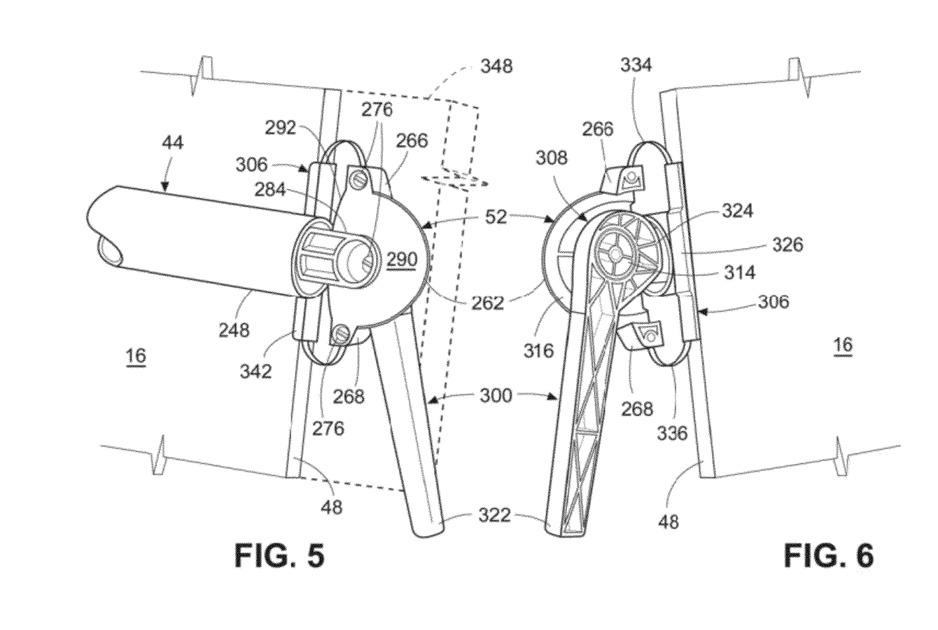

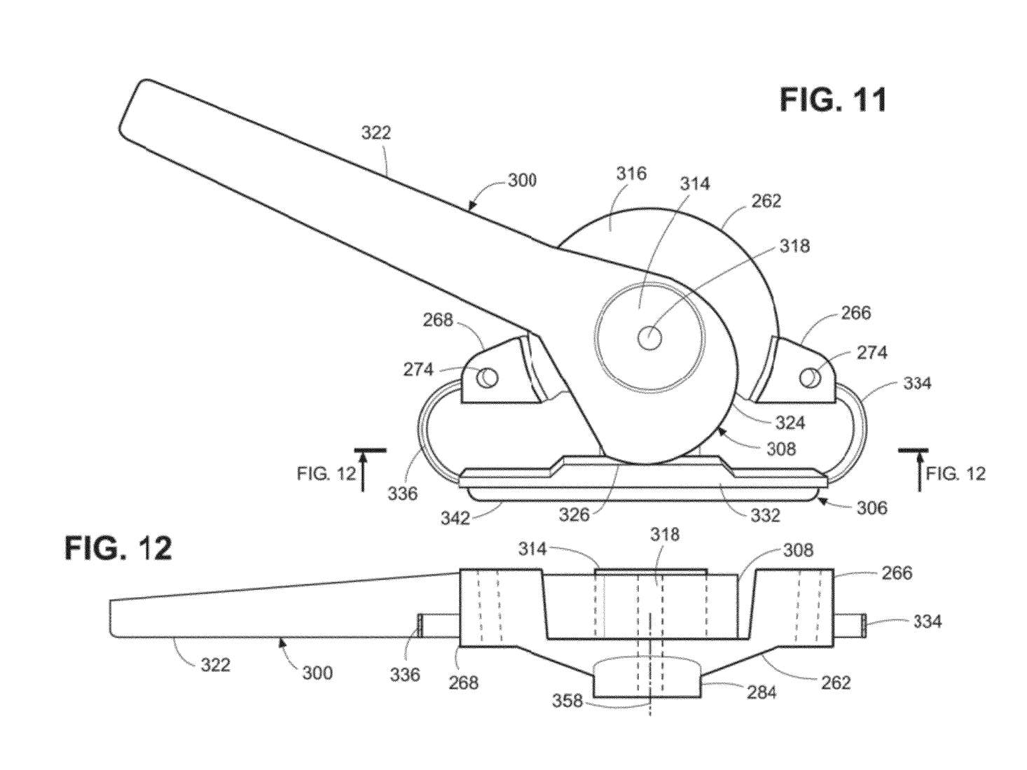

The cam tool and holding device 52 (FIG. 4) includes a base 262 with opposite peripheral ear portions 266 and 268 (FIGS. 5, 6, 11 and 13. A fastener opening 274 (FIG. 11) is provided in each ear portion 262 and 268 for reception of a fastener 276 (FIG. 5) for securing the base to a backup support wall 348 next to the edge 48 of the shower wall 16. Such securement establishes the fixation position of the device 52.

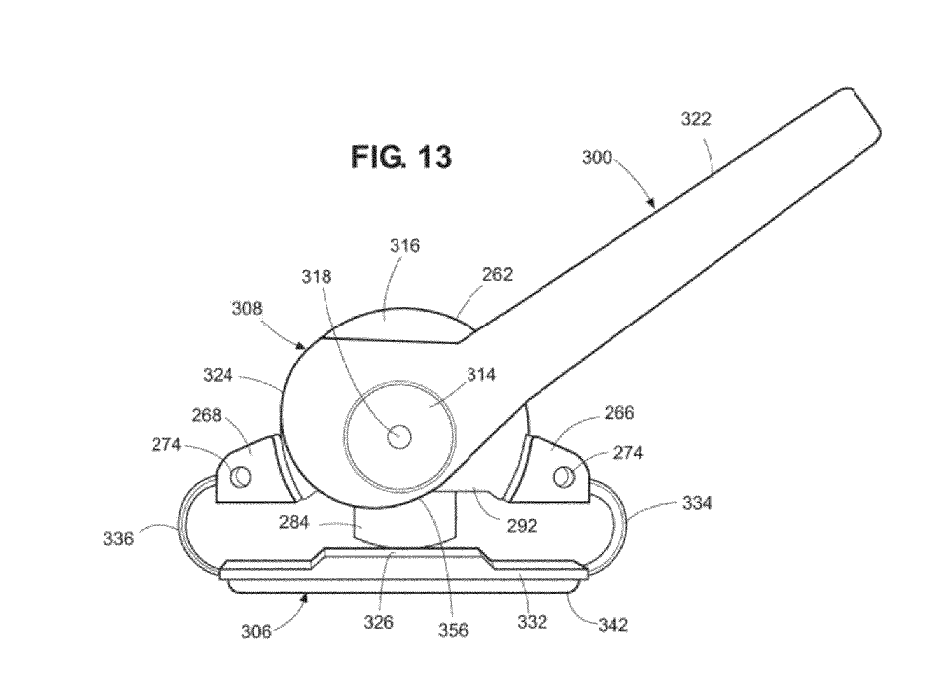

A support stub 284 (FIGS. 5 and 13) is formed on or joined to a top surface 290 (FIG. 5) of the base 262 and extends beyond a peripheral edge 292 (FIGS. 5 and 13) of the base 262. The support stub 284 is engageable with the end 248 of the support member 44 (FIGS. 2, 4 and 5) for supporting the end 248 in a position that is determined by the fixation position of the device 52.

The device 52 thus holds the support member 44 in its support position, wherein the support member 44 engages the pressure transfer member 26 (FIGS. 2 and 4) to maintain the pressure transfer member 26 in a desired pressure transfer position against the shower wall 16.

The cam tool and holding device 54, which is identical to the cam tool and holding device 52, is secured to a backup support wall 350 (FIG. 2) next to the edge 58 of the shower wall 18, to establish the fixation position of the device 54.

The device 54 also includes a support stub 284 that engages the end 256 (FIGS. 2 and 4) of the support member 46 when the device 54 is fixed in position on the support wall 350. The device 54 thus supports the end 256 of the support member 46 in a position that is determined by the fixation position of the device 54.

The device 54 therefore holds the support member 46 in a support position, wherein the support member 46 engages the pressure transfer member 28 (FIGS. 2 and 4) to maintain the pressure transfer member 28 in a desired pressure transfer position against the shower wall 18.

The cam tool and holding device 52 further includes a cam 300 and a cam follower 306. The cam 300 has a cam head 308 that is rotatable on a hub portion 314 that projects from a bottom surface 316 of the base 262, and is integral with the base 262.

The hub portion 314 is formed with an opening 318 (FIGS. 11-13) for a fastener 276 (FIG. 5).

A cam lever arm 322 (FIGS. 5 and 6) extends from the cam head 308. The cam head 308 has a cam surface 324 (FIGS. 6, 11 and 13) engageable with a cam engagement surface 326 on the cam follower 306.

The cam surface 324 or the cam engagement surface 326 can be provided with faceting (not shown) to reduce slippage between the surfaces 324 and 326 when engagement occurs.

The cam follower 306 has a driving surface 332 (FIGS. 11 and 13) opposite the cam engagement surface 326. The driving surface 332 (FIGS. 11-13) is engageable with the edge 48 (FIGS. 5 and 6) of the shower wall 16.

The cam follower 306 also includes flexible end straps 334 and 336 (FIGS. 5, 6 and 11-13) respectively joined to the ear portions 266 and 268 of the base 262 to permit movement of the cam follower 306 with respect to the base 262. The cam follower 306, the straps 334, 336, the base 262 and the ear portions 266 and 268 can be molded as a one-piece structure.

The cam follower further includes a surface contacting portion 342 for contacting the exposed surface of the shower wall 16 (FIGS. 5, 11 and 13).

The cam tool and holding device 54 also includes a cam 300 rotatably mounted on a hub 314, and a cam follower 306, as previously described for the cam tool and holding device 52.

During installation of the shower walls 16, 18 and 20 the walls 16, 18 and 20 are positioned in the shower wall enclosure 12 in a manner generally indicated in the FIGS. 1H to 1P. The shower walls 16, 18 and 20 are thus placed against the backup support walls 348, 350 and 352 (FIG. 2A), which are provided with a bonding material.

The bonding material will ultimately form a permanent bond between the shower walls 16, 18 and 20, and their backup support walls 348, 350 and 352.

However, to ensure adequate surface contact between the shower walls 16, 18 and 20, and their respective backup support walls 348, 350 and 352, it is desirable to apply pressure on the shower walls 16, 18 and 20 while the bonding material cures.

The system 10 provides the desirable pressure on the shower walls 16, 18 and 20 during the curing period of the bonding material.

However, before the entire system 10 is placed in the position of FIGS. 2 and 3, the cam tool and holding devices 52 and 54 are first installed. The devices 52 and 54 are initially used to slide the side shower walls 16, 18 against the rear shower wall 20. Thus when the bonding material cures a tight joint will be provided at the corners C and D (FIG. 2) between the side shower walls 16, 18 and the rear shower wall 20.

The cam tool and holding device 52 and 54 are thus affixed alongside the edges 48 and 58 of the shower walls 16 and 18 (FIGS. 2 and 4) in the manner indicated in FIG. 1R. If two sets of the system 10 are to be used, two cam tools and holding devices 52 are provided at the edge 48 of the shower wall 16 and two cam tools and holding devices 54 are provided at the edge 58 of the of the shower 18 in a manner similar to that indicated in FIG. 1X.

The cam tool and holding devices 52 and 54 are located relative to the edges 48 and 58 of the shower walls 16 and 18 such that the driving surface 332 of the cam follower 306 contacts the edges 48 and 58 of the shower walls 16 and 18 while a portion 356 (FIG. 13) of the cam surface 324 having the smallest radial distance from the cam pivot axis 358 (FIG. 12) at the center of the fastener opening 318 is arranged to contact the cam engagement surface 326 of the cam follower 306.

Under this arrangement rotation of the handle 322 of the cam 300 will cause the cam surface 324 to forcibly engage the cam engagement surface 326 on the cam follower 306. The force exerted by the cam surface 326 on the cam follower 306 is transferred to the driving surface 332 of the cam follower 306 that engages the edge 48 of the side wall 16, for example. Such force will urge the side wall 16 to slide toward the rear wall 20 thereby creating a tight corner engagement at the corner C between the wall 16 and the wall 20.

A similar operation is provided with the cam tool and holding tool 54 to cause the side shower wall 18 to slide toward the rear shower wall 20 thereby creating a tight corner joint at corner D between the wall 18 and the wall 20.

Once the tight corner joints have been established at the corners C and D (FIGS. 2 and 3) the other components of the system 10 in addition to the earn tool and holding devices 52 and 54 are put in place as shown in FIG. 3.

Thus the pressure transfer members 26, 28 and 30 are engaged with the adjustable force development means 36 and 38. The support members 44 and 46 are engaged with the pressure transfer members 26 and 28 as shown in FIGS. 2 and 3. The crank devices 36 and 38 of the force development devices are in a relatively light force development condition to facilitate location of the pressure transfer members 26, 28 and 30 on the shower walls 16, 18 and 20 in a desired pressure transfer position.

It will be noted that the cam tool and holding devices 52 and 54 in their previously affixed positions, dictate the height at which the system 10 is positioned in the shower enclosure 12.

Referring to FIGS. 2 and 4 with the system 10 thus positioned the crank devices 36 and 38 are rotated in a counterclockwise direction, for example, to spread the confronting ends of the struts 164 and 166 and thereby impose a force on the pressure transfer members 26 and 30 via the struts 164 and 166.

Similarly counterclockwise rotation of the crank member 220 of the force development device 38 will spread the confronting ends 230 and 232 of the struts 222 and 224 to impose a force on the pressure transfer members 28 and 30 via the struts 222 and 224.

The pressure transfer members 26 and 28 are held in position by the support members 44 and 46 and the pressure transfer member 30 is held in position, by a combination of the force imposed thereon by the force development devices 36 and 38 and the stabilization of the pressure transfer members 26 and 28 by the support members 44 and 46 and the devices 52 and 54.

The devices 52 and 54 hold the support members 44 and 46 in their respective support positions and ultimately maintain the pressure transfer members 26, 28 and 30 in their respective pressure transfer positions.

The affixation of the devices 52 and 54 alongside the shower walls 16 and 18 ensures stability of the system 10 during the installation of the shower walls 16, 18 and 20.

After a desirable cure period for the bonding material has elapsed, such as for example 24 hours, the system 10 can be removed from the shower walls 16, 18 and 20 by reducing the force imposed by the force development devices 36 and 38, disengaging the force development devices 36, 38 from the respective pressure transfer members 26, 28 and 30 and removing the support struts 44 and 46 from the devices 52 and 54. The devices 52 and 54 can then be detached from their affixed position alongside the edges 48 and 58 of the shower walls 16 and 18.

In another embodiment of the invention a system for installing shower walls in a two wall shower enclosure is generally indicated by the reference number 370 in FIG. 3. The two wall shower enclosure is generally indicated by the reference number 372, and includes shower walls 378 and 380. The shower walls 378 and 380 intersect at a corner angle E of approximately 90°, although other intersection angles are also feasible.

The system 370 (FIG. 3) includes the pressure transfer members 26 and 28 for the shower walls 378 and 380. Pressure is applied to the pressure transfer members 26 and 28 by the adjustable force development 36 (FIGS. 7 and 8) which engage the pressure transfer members 26 and 28.

The system 370 (FIG. 3) further includes the support members 44 and 46 which respectively engage the pressure transfer members 26 and 28.

The system 370 also includes the combination cam tool and holding devices 52 and 54 (FIGS. 5-13) that engage the support members 44 and 46.

The cam tool and holding devices 52 and 54 also engage edges 386 and 388 of the shower walls in a manner similar to that described for the system 10 engagement of the shower wall edges 44 and 58 by the devices 52 and 54.

The system 370 is operated in a manner similar to that previously described for the system 10. Thus the force development device 36 is operated to increase the space or distance between the confronting ends 188 and 204 of the struts 164 and 166 to impose a force on the pressure on the pressure transfer members 26 and 28 as previously described for the system 10.

The forces exerted on the pressure transfer members 26 and 28 are applied against the shower walls 378 and 380 after they have been shifted into a tight corner joint by the cam tool and holding devices 52 and 54 in a manner similar to that previously described for the system 10.

Thus the system 370 presses against and maintains the shower walls 378 and 380 in a desired securement position against backup support walls 394 and 396 until a bonding material for the shower walls dries and cures.

As various changes can be made in the above constructions and methods without departing from the scope of the invention, it is intended that all matter contained in the above description or shown in the accompanying drawings shall be interpreted as illustrative and not in a liming sense.

What is claimed is:

1. A system for installing shower walls comprising,
a) a pressure transfer member positionable against a shower wall for applying pressure against a shower wall to urge the shower wall against a shower wall support,
b) adjustable force development means, engageable with the pressure transfer member, for exerting a predetermined force against the pressure transfer member to enable the pressure transfer member to apply pressure against a shower wall,
c) elongated support means engageable with the pressure transfer member for maintaining the pressure transfer member in a pressure transfer position on a shower wall when the force development means exerts a predetermined force against a shower wall, and
d) fixation means joinable to the support means for holding the support means in a support position to enable the support means to is maintain the pressure transfer member in a pressure transfer position, said fixation means including a fixation portion securable in a fixed position alongside a shower wall.

2. The system of claim 1 including a predetermined number of said pressure transfer members corresponding to at least the number of shower walls being installed.

3. The system of claim 1 including two of said pressure transfer members spaced from each other, each said pressure transfer member being positionable against a separate shower wall, said adjustable force development means being elongated and including opposite force transmitting end portions, one of said force transmitting end portions being engageable with one of said pressure transfer members, and the other of said force transmitting end portions being engageable with the other of said pressure transfer members.

4. The system of claim 3 including two of said support means for engagement with respective ones of said pressure transfer members, said system further including two of said fixation means, one of said fixation means being joinable to one of said support means and the other of said fixation means being joinable to the other of said support means to hold the respective support means in respective support positions and enable the respective support means to maintain the respective pressure transfer members in selected pressure transfer positions.

5. The system of claim 3 wherein said support means has an opening and said fixation portion has a predetermined periphery and a stub-like projection extending beyond the predetermined periphery for engagement with the opening in said support means.

6. The system of claim 1 further including a cam and a cam follower on said fixation means for engaging an edge of a shower wall to exert a force on the edge of a shower wall to urge the shower wall to move or slide in a predetermined direction along a shower wall support.

7. The system of claim 6 wherein the cam includes a cam head pivoted to the fixation portion, the cam head having a cam surface, a lever arm joined to the cam head, the cam follower having a cam engagement surface engageable with the cam surface and an edge contact surface engageable with the edge of a shower wall, said cam follower being movably connected to the fixation portion to permit relative movement of the cam follower with respect to the fixation portion.

8. The system of claim 7 wherein the cam follower is connected to the fixation portion by flexible connection means that permit relative movement of the cam follower with respect to the fixation portion.

9. The system of claim 7 wherein said fixation portion includes means for detachable securement of the fixation portion in a fixed position alongside a shower wall.

10. The system of claim 1 wherein said fixation portion has a predetermined periphery, and an extension portion joined to the fixation portion, the extension portion extending beyond the periphery of the fixation portion for engagement with the support means.

11. The system of claim 10 wherein said support means includes an elongated support member having one end engageable with the pressure transfer member and an opposite end engageable with said extension portion.

12. The system of claim 11 wherein a cam and a cam follower are provided on said fixation portion for engaging an edge of a shower wall to exert a force on the shower wall to urge the shower wall to move or slide in a predetermined direction along a shower wall support.

13. A system for installing shower walls comprising,
a) a pair of spaced pressure transfer members, each said pressure transfer member having a base with a pressure transfer surface for applying pressure against a separate shower wall to urge the shower wall against a shower wall support,
b) an adjustable force development device including a threaded crank assembly having opposite end portions, and a pair of elongated struts having confronting end portions respectively engageable with the opposite end portions of the threaded crank assembly, said struts having non-confronting end portions respectively engageable with respective said pressure transfer members,
c) a pair of elongated support members, each having one end engageable with a respective one of said pressure transfer members and an opposite supportable end, and
d) a pair of holding members, each having a holding portion engageable with the supportable end of a respective one of said support members for holding the respective support members in respective support positions.

14. The system of claim 13 wherein each said holding member has a fixation portion securable in a fixed position alongside a shower wall, said fixation portion having a predetermined periphery, and an extension portion joined to the fixation portion, the extension portion extending beyond the periphery of the fixation portion for engagement with a respective one of the support members at the supportable end.

15. The system of claim 13 wherein said holding members each include a cam and a cam follower for engaging an edge of a shower wall to exert a force on the edge of the shower wall to urge the shower wall to move or slide in a predetermined direction along a shower wall support.

16. The system of claim 15 wherein the cam includes a base, a cam head pivoted to the base, the cam head having a cam surface, a lever arm joined to the cam head, the cam follower having a cam engagement surface engageable with the cam surface and an edge contact surface engageable with the edge of a shower wall, said cam follower being movably connected to the base to permit relative movement of the cam follower with respect to the base, and wherein the cam follower is connected to the base by flexible connection means that permit relative movement of the cam follower member with respect to the base.

17. The system of claim 13 including three of said spaced pressure transfer members and a pair of said adjustable force development devices each of said force development devices including said threaded crank assembly and said pair of elongated struts, a first pair of said elongated struts, corresponding to one of said adjustable force development devices, having non-confronting end portions respectively engageable with a first and second of said pressure transfer members, and a second pair of said elongated struts, corresponding to the second of said adjustable force development devices, having non-confronting end portions respectively to engageable with the second and third of said pressure transfer members, said one of each said elongated support member being respectively engageable with the first and third pressure transfer members, and the holding portion of each said holding member being respectively engageable with the supportable end of the respective support members for holding the respective support members in their respective support positions.

18. The system of claim 17 wherein each said holding member has a fixation portion securable in a fixed position alongside a shower wall, said fixation portion having a predetermined periphery and an extension portion joined to the fixation portion, the extension portion extending beyond the periphery of the fixation portion for engagement with a respective one of the support members at the supportable end.

19. The system of claim 17 wherein said holding members include a cam and a cam follower for engaging an edge of a shower wall to exert a force on the edge of the shower wall to urge the shower wall to move or slide in a predetermined direction along a shower wall support.

20. The system of claim 19 wherein the cam includes a base, a cam head pivoted to the base, the cam head having a cam surface, a lever arm joined to the cam head, the cam follower having a cam engagement surface engageable with the cam surface and an edge contact surface engageable with the edge of a shower wall, said cam follower being movably connected to the base to permit relative movement of the cam follower with respect to the base, and wherein the cam follower is connected to the base by flexible connection means that permit relative movement of the cam follower member with respect to the base.

21. A cam tool comprising,
a) a base
b) a cam and a cam follower, the cam having a cam head with a cam surface and the cam head being pivoted to the base,
c) the cam follower having a cam engagement surface engageable with the cam surface and a driving surface opposite the cam engagement surface, said cam follower being movably connected to the base to permit movement of the cam follower with respect to the base, and
d) a lever arm having one end portion joined to the cam head.

22. The cam tool of claim 21 wherein the cam follower is connected to the base by flexible connection means that permit movement of the cam follower with respect to the base.

23. The cam tool of claim 21 wherein cam follower has a surface contacting portion for contacting a shower wall surface, the surface contacting portion extending at right angles from the drive surface.

24. The cam tool of claim 21 further including means for permitting securement of said base in a fixed position to a support surface.
